(19) United States
(12) Patent Application Publication
(10) Pub. No.: US 2010/0292864 A1
(43) Pub. Date: Nov. 18, 2010

(54) AIR CONDITIONER AND METHOD OF CONTROLLING THE SAME

(76) Inventors: Dongwon Sung, Seoul (KR); Deok Huh, Seoul (KR); Jiwoong Kim, Seoul (KR); Gilbong Lee, Seoul (KR)

Correspondence Address: KED & ASSOCIATES, LLP, P.O. Box 221200, Chantilly, VA, 20153-1200, US

(21) Appl. No.: 12/780,264

(22) Filed: May 14, 2010

(30) Foreign Application Priority Data
May 15, 2009 (KR) 10-2009-0042737

(51) Int. Cl. G05D 23/19; F25B 49/00; H04L 9/32

(52) U.S. Cl. 700/300; 62/126; 726/3

(57) ABSTRACT

Disclosed are an air conditioner and a method of controlling the air conditioner. The air conditioner includes at least one outdoor unit; at least one indoor unit connected to the outdoor unit to discharge hot or cool air to the inside of a room; and a communication device connected to the outdoor unit, wherein the communication device explores a terminal within a predetermined distance, receives a request from the terminal to communicate data with the terminal in a wireless communication scheme, and transmits operating state data of the outdoor unit and the indoor unit to the terminal.

### CROSS-REFERENCE TO RELATED APPLICATION

This application claims the priority benefit of Korean Patent Application No. 10-2009-0042737, filed on May 15, 2009 in the Korean Intellectual Property Office, the disclosure of which is incorporated herein by reference.

### BACKGROUND OF THE INVENTION

1. Field of the invention

The present invention is directed to an air conditioner and a method of controlling the air conditioner, and more particularly to an air conditioner that may store and share data regarding operations of the air conditioner and a method of controlling the air conditioner.

2. Description of the Related Art

An air conditioner discharges cool/hot air to the inside of a room to adjust the temperature in the room and purifies the indoor air to provide a comfortable environment. In general, an air conditioner includes an indoor unit that has a heat exchanger and is provided in a room and an outdoor unit that has a compressor and a heat exchanger and supplies coolant to the indoor unit.

In the air conditioner, the indoor unit having the heat exchanger is controlled separately from the outdoor unit having the compressor and heat exchanger. Electric power supplied to the compressor or heat exchangers is controlled to operate the air conditioner. In the air conditioner, at least one indoor unit may be coupled with an outdoor unit. The indoor unit is supplied with coolant to operate the air conditioner in a room cooling or room heating mode depending on a desired operating state.

To monitor the operation of the air conditioner, a cable is connected from a designated terminal of the outdoor unit via a converter to a computing terminal, such as a laptop computer. A monitoring program installed in the computing terminal is executed to show date generated or measured while the indoor unit is operated, that is “air conditioner operating state data”.

When a malfunction or error takes place while the air conditioner operates, the monitoring program displays it on the screen of the computing terminal so that a tester can identify and get rid of it.

The convention monitoring method was burdensome because the monitoring procedure is complicated and the test should carry the cable and converter. Further, in case of a plurality of outdoor units, it was time consuming to monitor or test all of the outdoor units by connecting the cable and converter to each and every outdoor unit.

Therefore, there is a need of providing an air conditioner that may easily monitor the operation of the air conditioner by receiving the air conditioner operating state data from the air conditioner through wireless communication, and a method of controlling the air conditioner.

### SUMMARY OF THE INVENTION

According to an exemplary embodiment of the present invention, there is provided an air conditioner including: at least one outdoor unit; at least one indoor unit connected to the outdoor unit to discharge hot or cool air to the inside of a room; and a communication device connected to the outdoor unit, wherein the communication device explores a terminal within a predetermined distance, receives a request from the terminal to communicate data with the terminal in a wireless communication scheme, and transmits operating state data of the outdoor unit and the indoor unit to the terminal.

The terminal may include a program that analyzes the operating state data and monitors the operation of the outdoor unit and the indoor unit to determine whether or not there is an error and communicates with the communication device depending on a wireless communication scheme.

According to an exemplary embodiment of the present invention, there is provided a method of controlling an air conditioner including: exploring at least one terminal within a predetermined distance through a communication device of an outdoor unit in a wireless communication scheme; determining whether the explored terminal is a registered terminal; transmitting stored operating state data to the terminal through the communication device in case that the terminal is a registered terminal; and varying an operation setting in response to data received from the terminal to operate the air conditioner according to the varied operation setting.

According to an exemplary embodiment of the present invention, there is provided a method of controlling an air conditioner including: allowing a terminal to access a communication device connected to an outdoor unit in response to an access request from the communication device or a result of exploring the communication device within a predetermined distance; transmitting security data requested from the outdoor unit connected to the communication device to allow the outdoor unit to identify whether the terminal is a registered terminal and connect the terminal to the outdoor unit; receiving operating state data for the outdoor unit and an indoor unit connected to the outdoor unit from the outdoor unit to display the operating state data; and analyzing the operating state data to determine whether or not there is an error and display an analyzed result.

Since the air conditioner and the method of controlling the air conditioner according to exemplary embodiments may monitor the operating state of the air conditioner by using wireless communication, data sharing for determining the operating state of the air conditioner may be easily done and data can be conveniently collected from a plurality of air conditioners, thereby enhancing convenience and time required for data collection can be reduced, thereby improving efficiency of management.

### BRIEF DESCRIPTION OF THE DRAWINGS

FIG. 1 is a view illustrating a configuration of an air conditioner according to an exemplary embodiment of the present invention.

FIG. 2 is a view illustrating a configuration for data sharing between an air conditioner and a terminal through wireless communication according to an exemplary embodiment of the present invention.

FIG. 3 is a block diagram illustrating a configuration including an outdoor and a communication device according to an exemplary embodiment of the present invention.

FIG. 4 is a flowchart illustrating a connection of an outdoor unit to a communication device and a terminal registration process according to an exemplary embodiment.

FIG. 5 is a flowchart illustrating a method of controlling an air conditioner by data sharing through communication between an outdoor unit and a terminal according to an exemplary embodiment of the present invention.

FIG. 6 is a flowchart illustrating data flow between an outdoor unit and a terminal according to an exemplary embodiment of the present invention.

### DETAILED DESCRIPTION OF THE PREFERRED EMBODIMENTS

Hereinafter, exemplary embodiments of the present invention will be described with reference to accompanying drawings.

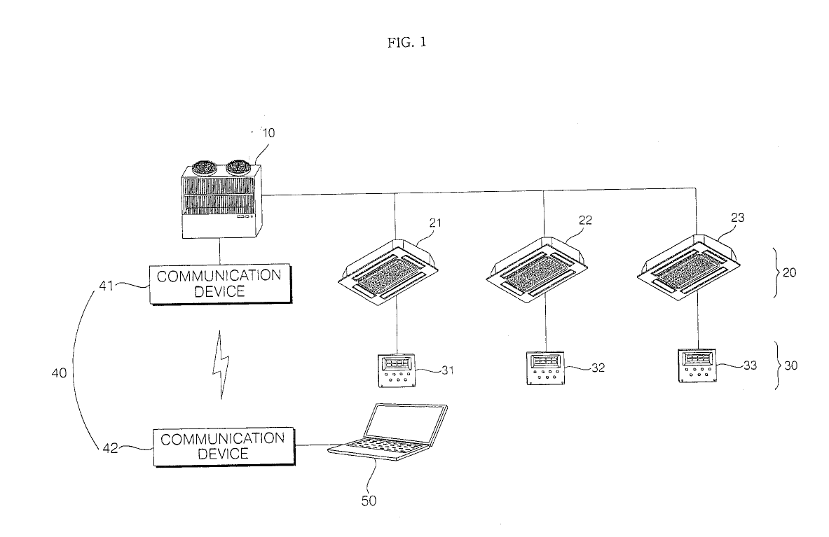

FIG. 1 is a view illustrating a configuration of an air conditioner according to an exemplary embodiment of the present invention.

Referring to FIG. 1, the air conditioner includes at least one outdoor unit 10, at least one indoor unit 20 (21, 22, and 23), and a local controller 30 (31, 32, and 33). The air conditioner may further include a remote controller (not shown) that collectively controls and monitors the indoor unit and the outdoor unit, but the descriptions will be omitted for purpose of brevity.

The air conditioner further includes a communication device 41 and a terminal 50. The communication device 41 is connected to the outdoor unit to wirelessly transmit data from the outdoor unit to the terminal 50 and receive data from the terminal 50. The terminal 50 communicates with the outdoor unit based on a wireless communication scheme to receive operating state data from the indoor unit and the outdoor unit.

The air conditioner may further include an air purifying unit, a humidifying unit, a dehumidifying unit, and a heater other than the indoor unit 20 and the outdoor unit 10. Although a system air conditioner has been exemplified in the exemplary embodiment, other types of air conditioners, such as including a standing type or wall mounting type, may be used.

The indoor unit 20 (21, 22, and 23) discharges hot or cool air to the inside of a room. The indoor unit 20 includes an indoor heat exchanger (not shown), an indoor unit fan (not shown), an expanding valve (not shown) for expanding coolant supplied from the outdoor unit, a plurality of sensors (not shown), and a controller (not shown) for controlling the operation of the indoor unit. The indoor unit may further include an input unit (not shown) for inputting a user command and an output unit (not shown) for displaying the operation.

The local controller 30 (31, 32, and 33) is connected to the indoor unit 20 to display the operation state of the indoor unit and transmit a control command corresponding to inputted data to the indoor unit. The local controller may be connected to the indoor unit in wired or wireless manner to perform unilateral or bilateral communications with the indoor unit based on a communication scheme. The remote controller is connected to a plurality of indoor units or outdoor units to control the operation of the units. The remote controller also sets up an operation schedule of each unit so that the units may be operated according to the schedule.

The outdoor unit 10 includes a compressor (not shown) for compressing supplied coolant, a heat exchanger (not shown) for performing heat exchanging between the coolant and outdoor air, an outdoor fan (not shown), an accumulator (not shown) for extracting gaseous component from supplied coolant and supplying the extracted gaseous component to the compressor, and a four-way valve (not shown) for selecting a path of the coolant according to a room heating operation. The outdoor unit may further include a pressure sensor that measures the pressure of coolant discharged from the compressor and the pressure of coolant supplied to the compressor and a temperature sensor that is connected to coolant piping to measure the temperature of the coolant. Besides, the outdoor unit may further include a plurality of sensors and valves, and an oil collector whose detailed descriptions will be omitted for purpose of brevity.

The outdoor unit 10 may be connected to a plurality of indoor units, and as the case may be, a plurality of outdoor units may be connected to one another. Each outdoor unit may supply coolant to each of the connected indoor units and the plurality of outdoor units may supply coolant to the plurality of indoor units. The outdoor unit 10 is driven in response to a request from at least one of the plurality of indoor units 21 to 23. As cooling/heating capacity varies corresponding to the driven indoor unit, the number of operating outdoor units and the compressors included in the outdoor units is changed.

The outdoor unit and the indoor unit are connected to each other through coolant piping to perform room cooling or heating according to the flow of the coolant and communicate data with each other based on a predetermined communication scheme.

The outdoor unit 10 transmits operating state data to the terminal through the communication device 41 based on a wireless communication scheme.

The communication device 41 may be embedded in the outdoor unit and connected to the external through an interface. The communication device 41 may perform communications based on at least one of various wireless communication schemes, such as, for example, Bluetooth, wireless LAN (“WIFI”), Wibro™ (also referred to as “mobile WiMax”) and infrared communication.

The terminal 50 may internally or externally include a communication device 42 to communicate data with the communication device 41 in the same communication scheme as that of the communication device 41. The terminal 50 receives operating state data from the outdoor unit and displays the received operating state data in order for a tester to monitor the operation of the air conditioner. Further, the terminal 50 may generate a control command corresponding to inputted data and transmit the control command to the outdoor unit via the communication device 42.

The terminal 50 may include, but not limited to, a mobile terminal having wireless communication functions, such as a PDA, a laptop computer, or a net book. Any terminal that may be connected with the communication device 40 to perform wireless communications may be used for the terminal 50.

The terminal 50 may be previously registered to access the outdoor unit 10. The terminal 50 may initially gain access to the outdoor unit through authentication or registration processes. Access to the outdoor unit and data receipt through the communication device 40 may require a predetermined authentication process. In this case, authentication data may comply with authentication information generated upon registration.

The terminal 50 may be installed with a monitoring program for monitoring the outdoor and indoor units. The monitoring program analyzes received operating state data and displays resultant monitoring data so that a tester may determine whether or not there is an error.

The terminal 50 receives and stores operating state data for each outdoor unit and analyzes the operating state data to determine whether each of the outdoor and indoor units has faults.

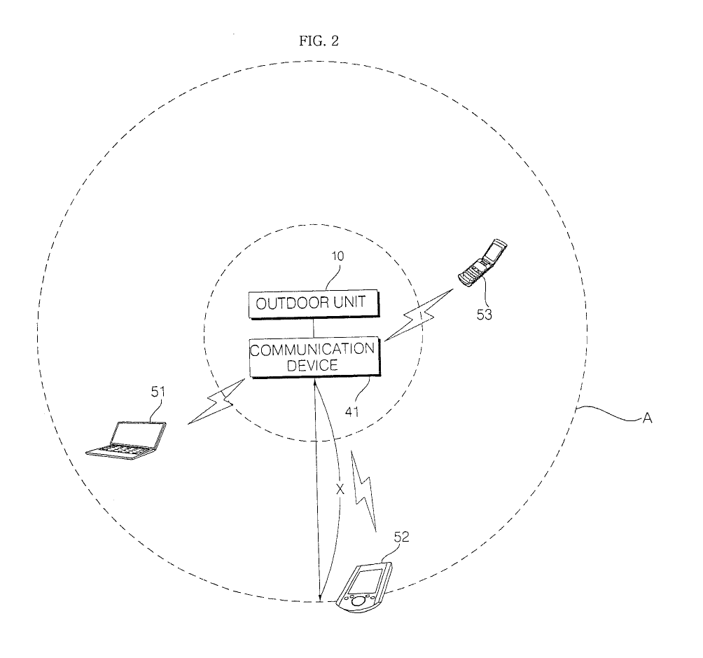

FIG. 2 is a view illustrating a configuration for data sharing between an air conditioner and a terminal through wireless communication according to an exemplary embodiment of the present invention.

Referring to FIG. 2, the outdoor unit 10 and the terminal 50 communicate with each other within a predetermined distance X through the communication device 40, specifically through the communication device 41 connected to the outdoor unit 10 and the communication device 42 connected to the terminal 50. Distance X is an arrival distance of a signal transmitted from the communication device, and may be varied depending on the type of communication device, used frequency, or communication scheme.

The terminal 50 explorers the outdoor unit 10 within a predetermined distance according to a wireless communication scheme, and if the outdoor unit is detected, accesses the detected outdoor unit to receive operating state data from the outdoor unit.

One of the outdoor unit and the terminal may operate in a server mode depending on the used wireless communication scheme. For example, in case of transmitting data by using Bluetooth, the communication device 41 of the outdoor unit may play a role as a server and the communication device 42 of the terminal may function as a client to explore and access the outdoor unit through a signal transmitted from the server, that is, the communication device 41.

Registration may be mutually performed between the communication device of the outdoor unit and the communication device of the terminal for access to the explored device. In the initial exploration, a separate registration process is conducted.

In this case, the plurality of terminals 51 to 53 may explore the outdoor unit, but only the registered terminal may access the outdoor unit and communicate data with the outdoor unit. Unregistered terminals may explore the outdoor unit, but not actually transmit and receive data to/from the outdoor unit.

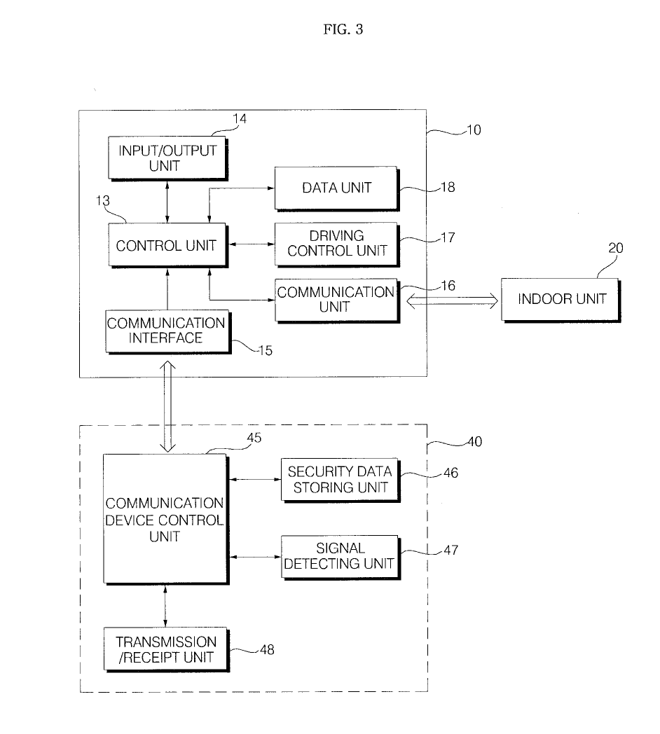

FIG. 3 is a block diagram illustrating a configuration including an outdoor and a communication device according to an exemplary embodiment of the present invention.

Referring to FIG. 3, the outdoor unit 10 includes an input/output unit 14, a control unit 13, a communication interface 15, a data unit 18, a driving control unit 17, and a communication unit 16.

The communication device 40 connected to the outdoor unit 10 includes a communication device control unit 45, a security data storing unit 46, a signal detecting unit 47, and a transmittance/receipt unit 48.

Although it has been described as below that the communication device 40 is connected through the communication interface 15 to the exterior, the communication device 40 may be detachably coupled with the outdoor unit or embedded in the outdoor unit. Further, the communication device 940 may be provided at the inside or outside of the indoor unit according to the location of sharing data.

The input/output unit 14 includes an input means for inputting a driving command of the outdoor unit and setup data regarding the operation of the outdoor unit, and a display means for displaying the operation state of the outdoor unit. The operation state of the outdoor unit may be also identified by the indoor unit 20 connected to the outdoor unit. The basic settings for an operating mode of the outdoor unit may vary with data inputted from the indoor unit 20.

The data unit 18 stores control data for controlling the operation of the outdoor unit, and operating state data and setup data of the outdoor unit and indoor unit. In response to a request of the terminal 50, the data of the outdoor unit and the indoor unit as stored in the data unit 18 are transmitted to the terminal through the communication device 40 according to a control command of the control unit 13.

The operating state data of the outdoor and indoor units as stored in the data unit 18 may include data regarding the operation of the outdoor and indoor units, such as operation settings of the outdoor and indoor units, sensed temperature and pressure, information on operating device, and the number of revolutions of a motor.

Further, the data unit 18 may store data required for connection to the communication device through the communication interface 15 and data necessary for data transmission/receipt with the communication device.

The driving control unit 17 controls the components of the outdoor unit to perform their own operations in response to the control command of the control unit 13. For example, the driving control unit 17 drives the compressor, the outdoor fan, the valves, and the sensor, thus operating the outdoor unit.

The communication unit 16 is connected to the indoor unit 20 through a communication scheme in the air conditioner. The communication unit 16 applies a control signal or data received from the indoor unit 20 to the control unit 13 and stores the control signal or data to the data unit 18 in response to a control command of the control unit 13.

The communication interface 15 may include a plurality of connection ports, such as, for example, a connection port for connecting to other units or a connection port for connecting or mounting the communication device.

When a device is mounted or cable-connected to the connection port, the communication interface 15 senses this and applies a sensing signal to the control unit 13. The communication interface 15 also transmits predetermined data to a connected device, for example, the communication device in response to a control command of the control unit 13, or receives data from the communication device and supplies the received data to the control unit 13.

In response to at least one of inputted control command, a request of the indoor unit 20, and data inputted from the input/output unit 14, the control unit 13 supplies a control command to the driving control unit 17 to operate the outdoor device and stores operating data of the outdoor unit and operating data of the indoor unit as received through the communication unit 16 to the data unit 18.

When the communication device 40 is connected to the communication interface 15, the control unit 13 is connected to the terminal 50 through the communication interface 15 to perform data transmission and receipt. The control unit 13 transmits the operating data of the outdoor unit or indoor unit as stored in the data unit 18 through the communication device 40 to the registered terminal 50. When predetermined control data is inputted from the terminal 50, the control unit 13 may receive the control data and generate a control command to operate the outdoor unit or indoor unit based on the control data, and supply the generated control command to the driving control unit 17 or the indoor unit 20.

Upon connection of the communication device 40, the control unit 13 may record information on the communication device 40 and store to the communication device 40 security data necessary for data communication with the terminal 50 using the communication device. The security data is stored in the data unit 18 of the outdoor unit, too.

Upon connection of the communication device 40, the control unit 13 may operate in a server mode or client mode by using the communication device 40. In case of the server mode, the control unit 13 may perform authentication of the terminal and then data transmission/receipt in response to an access request from the terminal, and in case of the client mode, the control unit 13 may request access to the terminal to transmit/receive data depending on an exploring result. The server mode or client mode may be changed depending on the communication scheme of the communication device. With respect to the functions, the outdoor unit may be operated depending on the communication scheme provided by the communication device, and actual communication connection mode and operation may be controlled by the communication device.

In the event of no connection of the terminal under the server mode, the control unit 13 maintains a standby state. Thereafter, upon an access request of the terminal, the control unit 13 receives the access request through the communication device, determines whether the terminal has been already registered, and if so, connects to the terminal to transmit and receive data to/from the terminal.

The communication device 40 is connected to the communication interface 15 of the outdoor unit 10 to transmit and receive a predetermined signal or data to/from the outdoor unit. As necessary, the communication device 40 may be embedded in the outdoor unit.

The communication device 40 includes a communication device control unit 45, a security data storing unit 46, a signal detecting unit 47, and a transmission/receipt unit 48. Further, the communication device 40 may include a connection port (not shown) coupled with the communication interface 15 of the outdoor unit.

When connected to the communication interface 15 of the outdoor unit the communication device control unit 45 indentifies the connection through signal communication with the control unit 13 and permits the outdoor unit to transmit data according to a communication scheme of the communication device.

The communication device control unit 45 enables the outdoor unit to operate in a server mode or client mode depending on a set mode. By doing so, the outdoor unit may explore a terminal within a predetermined distance or receive an access request from the terminal and supply the received access request to the control unit 13 so that the outdoor unit and the terminal 50 are connected to each other to transmit and receive data.

The communication device control unit 45 may perform authentication on the explored terminal or terminal having generated the access request, registration of the terminal, and deletion of the information on the registered terminal.

The communication device control unit 45 may transmit registration information of the terminal to the outdoor unit and determine whether to permit the terminal to access the outdoor unit depending on the result determined by the outdoor unit. According to a setting, the communication device control unit 45, on its own, may determine whether the terminal is a registered terminal and permit or deny access to the outdoor unit.

The security data storing unit 46 stores data for authentication of the terminal. For example, when authentication of the terminal is performed in the communication device, registration information on the terminal is stored as security data which is in turn used in the course of authentication of the communication device control unit 45.

In response to a control command of the communication device control unit 45, the signal detecting unit 47 explores a terminal using the same communication scheme within a predetermined distance. The signal detecting unit 47 supplies information on the explored terminal to the communication device control unit 45.

The transmission/receipt unit 48 receives data from the terminal 50 and supplies the received data to the communication device control unit 45, and transmits specific data to the terminal in response to a control command of the communication device control unit 45.

The communication device control unit 45 supplies data received from the terminal to the outdoor unit through the communication interface and allows the data received from the outdoor unit to be transmitted through the transmission/receipt unit 48.

The terminal 50 may perform data transmission and receipt in the same communication scheme as that of the communication device. A communication module according to the communication scheme of the communication device may be embedded in the terminal or a communication device may be externally connected to the terminal for data communication.

The terminal may also operate in a server mode or client mode, explore an adjacent outdoor unit and connect to the explored outdoor unit, and as necessary, connect to an outdoor unit in response to an access request from the outdoor unit to perform data transmission and receipt.

The terminal 50 may display data received from the outdoor unit via the communication device on a screen and analyze the data to provide predetermined statistical data or analysis data on the state of the outdoor unit.

Further, the terminal 50 may supply control data to the outdoor unit through a control menu to change the operation of the outdoor unit or indoor unit. In this case, the terminal may be operated by the remote controller.

The operation of an air conditioner according to an exemplary embodiment will now be described.

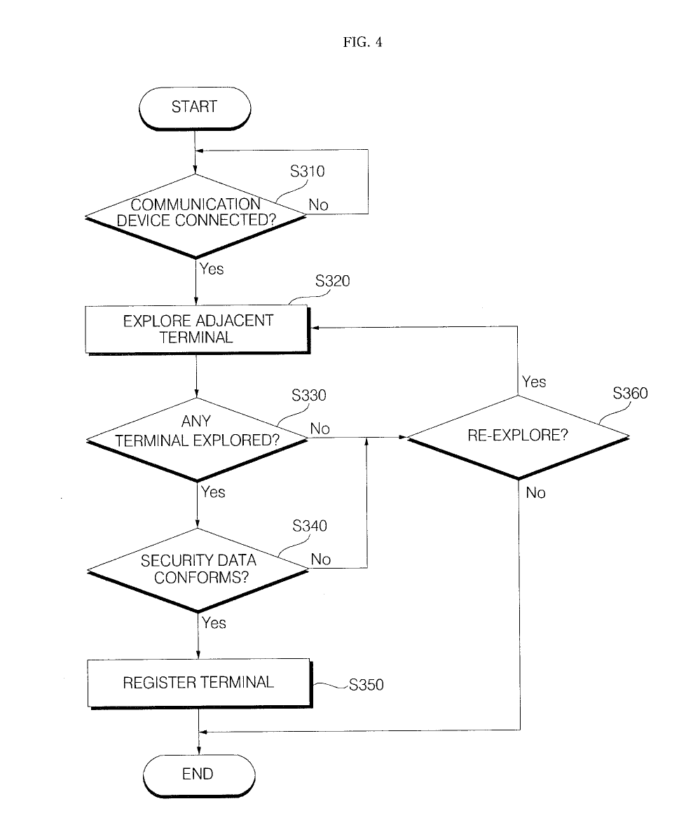

FIG. 4 is a flowchart illustrating a connection of an outdoor unit to a communication device and a terminal registration process according to an exemplary embodiment. Referring to FIG. 4, the indoor unit and the outdoor unit of the air conditioner operate in a predetermined operation mode corresponding to an inputted setting, and change the operation setting or control the operation in response to inputted control data.

The outdoor unit 10 is connected to the indoor unit 20 to receive operating state data of the indoor unit from the indoor unit and store the operating state data to the data unit 18. And, the outdoor unit 10 stores its own operating state data to the data unit 18.

When the communication device 41 has been already connected or now connected to the outdoor unit 10 (S310), the outdoor unit may connect to the terminal within a predetermined distance by using the communication device and transmit and receive data to/from the terminal.

The outdoor unit 10 registers a terminal to which operating state date of the outdoor unit or indoor unit is transmitted through the communication device 41 and only permits access from the registered terminal.

The outdoor unit 10 explores adjacent terminals through the communication device (S320). The communication device 41 may perform exploration on any terminal having a communication module using the same communication scheme as that of the communication device 41.

The control unit 13 identifies security data for the explored terminal to determine whether or not the security data conforms to that owned by the control unit 13 (S340), and, if so, registers the terminal to be capable of sharing data (S350). The control unit 13 stores the security data along with terminal information such as specific code information of the terminal or type of the terminal.

As necessary, the outdoor unit 10 may operate in a server mode to broadcast a certain signal so that a terminal may receive the signal to request registration. The control unit 13 previously exchanges security data with the terminals having shared data and registers a terminal having security data identical to that of the control unit 13.

In case that no terminals are explored, the outdoor unit performs a re-exploration (S360), and if no terminals are explored more than a predetermined number of times or a command for stopping the exploration is inputted, the outdoor unit ends exploration to terminate terminal registration.

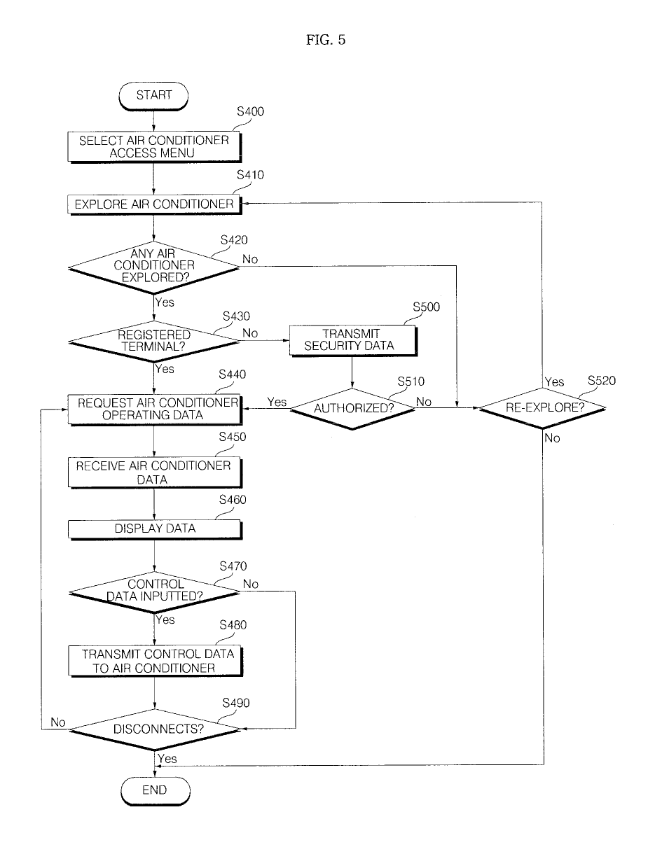

FIG. 5 is a flowchart illustrating a method of controlling an air conditioner by data sharing through communication between an outdoor unit and a terminal according to an exemplary embodiment of the present invention.

Referring to FIG. 5, when an air conditioner access menu is selected to receive data from the air conditioner (S400), the terminal 50 explores the air conditioner by using the communication module and connected communication device (S410).

When the air conditioner is explored (S420), the terminal requests access to the air conditioner and the air conditioner identifies whether the terminal is a registered terminal. When determined to be a registered terminal, the terminal is connected to the air conditioner. The terminal 50 may be connected to the outdoor unit among the plurality of units included in the air conditioner.

The terminal 50 requests the air conditioner to send operating data (S440), and the air conditioner transmits operating data to the terminal 50 in response to the request (S450). The terminal 50 displays the received data (S460).

Accordingly, a user of the terminal may receive data from the air conditioner without directly connecting a cable to the air conditioner and identify the operating state of the air conditioner.

Upon receiving predetermined control data for operation of the air conditioner (S470), the terminal 50 transmits the control data to the air conditioner (S480).

When a command for releasing connection to the air conditioner is inputted or connection is released by the air conditioner, the terminal 50 disconnects itself from the air conditioner (S490).

If the terminal 50 is not a registered terminal upon request of access to the air conditioner (S430), the terminal 50 transmits security data (S500) to the air conditioner to request authorization (S510) and if authorization is complete, then the terminal receives and displays data from the air conditioner as described above (S440 to S500). Further, the terminal may be registered to the air conditioner when the authorization is complete.

When not authorized (S510), the terminal attempts to re-explore for access to another air conditioner (S520).

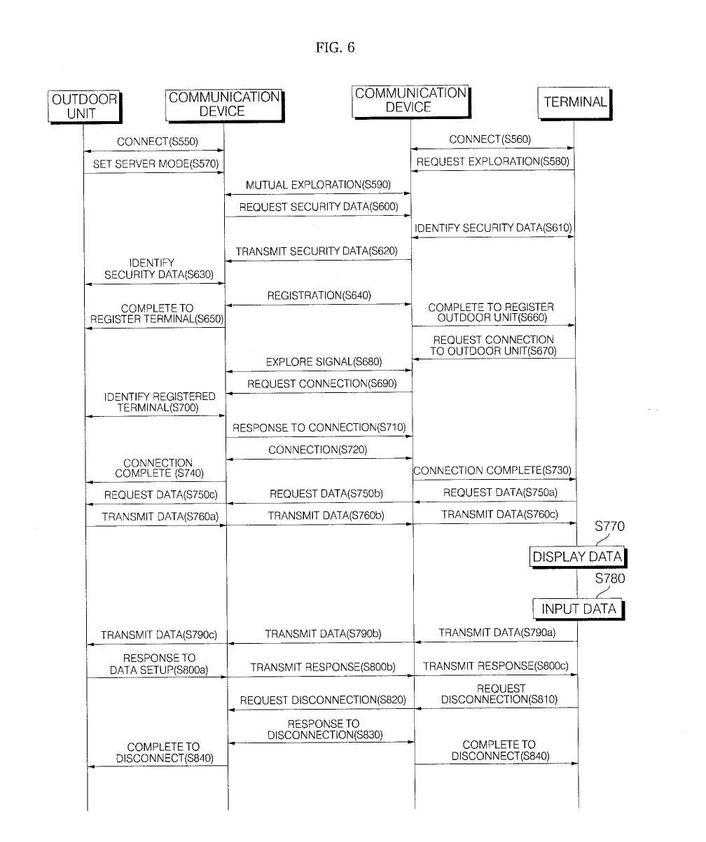

FIG. 6 is a flowchart illustrating data flow between an outdoor unit and a terminal according to an exemplary embodiment of the present invention.

Referring to FIG. 6, an outdoor unit and a communication device are connected to each other (S550), the communication device is set in a server mode (S570) to broadcast a predetermined signal.

A terminal is connected to a communication device (S560) and instructs the communication device to detect a peripheral signal (S580). In response to the instruction, the communication device attempts to detect a peripheral signal (S590). If the communication device of the terminal detects a signal from the communication device of the outdoor unit, the communication device of the terminal requests a connection and the communication device of the outdoor unit requests the terminal to send security data (S600).

In response to the request, security data is identified on the side of the terminal (S610) and transmitted to the outdoor unit's side (S620).

The outdoor unit identifies the received security data and authenticates the terminal (S630). If the security data conforms to security data already stored in the outdoor unit or satisfies a predetermined condition, the outdoor unit registers the terminal (S640). A signal of identifying the completeness of registration is transmitted to the terminal (S600).

When the terminal requests the communication device to access the outdoor unit (S670), the communication device explores a signal (S660) and, according to its result, requests access to the outdoor unit (S690).

In response to the access request from the terminal's side, the outdoor unit's side identifies whether the terminal is a registered one (S700), and if so, transmits a response of permitting a connection to the terminal's side (S710). Accordingly, the terminal and the outdoor unit are connected to each other via the communication devices (S720). The communication devices notify the outdoor unit and the terminal that connection has been complete (S730 and S740).

The terminal's side requests the outdoor unit to send data (S750a) and the communication device of the terminal sends the data request to the outdoor unit's side (S750b) and the outdoor unit receives the data request (S750c).

In response to the data request, the outdoor unit instructs the communication device to transmit stored operating state data of the outdoor unit and indoor unit to the terminal's side (S760a), the communication device transmits the operating state data in response to the instruction (S760b), and the terminal receives the data via the communication device connected thereto (5760c).

The terminal displays the received data (S770) and, as necessary, may analyze the data and outputs the analyzed results.

If data is inputted (S780), the terminal transmits the inputted data to the outdoor unit's side via the communication device (S790a and S790b) and then the outdoor unit receives the data from the terminal (S790c). Based on the received data, the outdoor unit may change the operation or settings of the outdoor unit or indoor unit and transmits a response to the terminal's side (S800a, S800b, and S800c).

If the terminal intends to disconnect to the outdoor unit, the terminal makes a request of disconnection (S810), which is in turn transmitted to the outdoor unit's side (S820). According to a response of disconnection from the outdoor unit's side, disconnection is complete (S840 and S850). The disconnection request may be made from the outdoor unit's side to the terminal.

As described above, since the outdoor unit stores the operating state data and the terminal may receive the data from the outdoor unit within a predetermined distance, a user may easily collect the data without moving to the outdoor unit.

The invention has been explained above with reference to exemplary embodiments. It will be evident to those skilled in the art that various modifications may be made thereto without departing from the broader spirit and scope of the invention. Further, although the invention has been described in the context its implementation in particular environments and for particular applications, those skilled in the art will recognize that the present invention's usefulness is not limited thereto and that the invention can be beneficially utilized in any number of environments and implementations. The foregoing description and drawings are, accordingly, to be regarded in an illustrative rather than a restrictive sense.

What is claimed is:

1. An air conditioner comprising:
at least one outdoor unit;
at least one indoor unit connected to the outdoor unit to discharge hot or cool air to the inside of a room; and
a communication device connected to the outdoor unit, wherein the communication device explores a terminal within a predetermined distance, receives a request from the terminal to communicate data with the terminal in a wireless communication scheme, and transmits operating state data of the outdoor unit and the indoor unit to the terminal.

2. The air conditioner of claim 1, wherein
the outdoor unit includes a control unit that if the terminal is detected by the communication device of the outdoor unit, identifies whether or not the terminal is a registered terminal and performs authentication on the terminal to transmit the operating state data to the terminal via the communication device.

3. The air conditioner of claim 3, wherein
the outdoor unit further includes a data unit that stores operating data of the indoor unit and operating data of the outdoor unit, wherein the control unit transmits the operating state data including the operating data of the outdoor unit and the indoor unit as stored in the data unit to the terminal.

4. The air conditioner of claim 1, wherein
the communication device enables the outdoor unit to operate in a server mode or client mode depending on a setting, wherein in the server mode setting, the communication device connects the terminal and the outdoor unit to each other in response to a request from the terminal and in the client mode setting, the communication device explores the terminal and connects the terminal and the outdoor unit to each other.

5. The air conditioner of claim 1, wherein
the terminal includes a program that analyzes the operating state data and monitors the operation of the outdoor unit and the indoor unit to determine whether or not there is an error and communicates with the communication device depending on a wireless communication scheme.

6. The air conditioner of claim 5, wherein
after completely receiving the operating state data for the outdoor unit, the terminal connects to another outdoor unit and receive operating state data of the outdoor unit.

7. The air conditioner of claim 5, wherein
the terminal operates in a server mode or client mode according to a setting and when the communication device is in a server mode, connects to a server in a client mode and when the communication device is in a client mode, connects to the outdoor unit in a server mode in response to a request from the communication device.

8. The air conditioner of claim 5, wherein
the terminal transmits inputted control data to the outdoor unit via the communication device so that the operation of the outdoor unit or the indoor unit connected to the outdoor unit may be varied.

9. A method of controlling an air conditioner comprising:
exploring at least one terminal within a predetermined distance through a communication device of an outdoor unit in a wireless communication scheme;
determining whether the explored terminal is a registered terminal;
transmitting stored operating state data to the terminal through the communication device in case that the terminal is a registered terminal; and
varying an operation setting in response to data received from the terminal to operate the air conditioner according to the varied operation setting.

10. The method of claim 9, further comprising:
in case that the terminal is not a registered terminal, performing authentication on the terminal and if the authentication is successful, registering the terminal.

11. The method of claim 9, further comprising:
prior to exploring the terminal, if the communication device is set in a server mode, determining whether the terminal is a registered terminal in response to an access request from the terminal to transmit the operating state data.

12. A method of controlling an air conditioner comprising:
allowing a terminal to access a communication device connected to an outdoor unit in response to an access request from the communication device or a result of exploring the communication device within a predetermined distance;
transmitting security data requested from the outdoor unit connected to the communication device to allow the outdoor unit to identify whether the terminal is a registered terminal and connect the terminal to the outdoor unit;
receiving operating state data for the outdoor unit and an indoor unit connected to the outdoor unit from the outdoor unit to display the operating state data; and
analyzing the operating state data to determine whether or not there is an error and display an analyzed result.

13. The method of claim 12, wherein
if it is determined that the outdoor unit or the indoor unit connected to the outdoor unit has an error, displaying an error message and transmitting the data containing the error message to the outdoor unit.

14. The method of claim 12, wherein
if control data regarding the operation of the indoor unit or outdoor unit is inputted after connection of the outdoor unit, transmitting the control data to the outdoor unit.

15. The method of claim 12, further comprising:
after receiving the operating state data from the outdoor unit, releasing the connection to the outdoor unit and connecting to another outdoor unit to receive operating state data of the outdoor unit.
